(19) United States
(12) Patent Application Publication
(10) Pub. No.: US 2007/0279713 A1
(43) Pub. Date: Dec. 6, 2007

(54) CONTACT IMAGE SENSOR FOR GENERATING MULTI-RESOLUTIONS

(75) Inventors: Chang-Yung Feng, Taipei (TW); Hung-Tse Lin, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/456,019

(22) Filed: Jul. 6, 2006

(30) Foreign Application Priority Data
Jun. 2, 2006 (TW) 095119542

(51) Int. Cl. H04N 1/46

(52) U.S. Cl. 358/514; 358/484

(57) ABSTRACT

A contact image sensor includes a first optical sensing element and at least one additional optical sensing element. The first optical sensing element includes plural optical sensing units arranged in a line along a first direction. Plural first image units are successively generated when the first optical sensing element senses a first source light. The at least one additional optical sensing element is disposed at a lateral side of the first optical sensing element, and includes plural optical sensing units arranged in a line along the first direction. When the additional optical sensing element senses an additional source light, plural additional image units are successively generated. The adjacent optical sensing units of the first optical sensing element and the at least one additional optical sensing element are partially overlapped with each other along a second direction, which is perpendicular to the first direction.

### FIELD OF THE INVENTION

The present invention relates to an image sensor, and more particularly to a contact image sensor for generating multi-resolutions.

### BACKGROUND OF THE INVENTION

Scanning apparatuses are commonly used in offices or homes for scanning for example documents, photographs, graphs or films. The scanned images can be converted into digital electronic files, which are then stored in a computer. Moreover, some digitalized processing operations such as digital display, editing, saving and outputting operations may be performed on the digital electronic files by the computer.

Generally, the optical sensors used in the scanning apparatuses are classified into two types, i.e. a charge couple device (CCD) and a contact image sensor (CIS). Since the charge couple device has a relatively higher scanning speed, the charge couple device is commonly used in the scanning apparatus. Unfortunately, since a complex optical system is required for the charge couple device, the overall volume of the scanning apparatus is not easily shrunken.

In contrast, the configuration, the operating mechanism and the optical path of the contact image sensor (CIS) are simpler because the optical source, the lens and other components are integrated into the contact image sensor. As such, the scanning apparatus may be made slimmer and smaller. Nowadays, since the contact image sensor meets the requirement of the further electronic product, many manufactures make efforts in developing the technologies of the contact image sensor applied to the scanning apparatus. Therefore, the scanning apparatus having the contact image sensor, which is also referred as a CIS scanning apparatus, is the issue of this disclosure.

Referring to FIG. 1, a schematic perspective view of a conventional CIS scanning apparatus is illustrated. The CIS scanning apparatus 10 includes a casing 11, a transparent platform 12 and a contact image sensor (CIS) 13. The transparent platform 12 is disposed on the upper surface of the casing 11 and used for placing thereon the document 14 to be scanned. The contact image sensor 13 is arranged within the casing 11.

Please refer to FIGS. 2(a) and 2(b). FIG. 2(a) is a schematic diagram illustrating the scanning operation concept of the CIS scanning apparatus 10, and FIG. 2(b) is schematic view showing n counts of rectangular scanning regions of the document portion to be scanned by the CIS scanning apparatus 10. Hereinafter, the operation principles of the CIS scanning apparatus 10 will be illustrated with reference to FIGS. 2(a) and 2(b) as well as FIG. 1.

As shown in FIG. 2(a), the CIS scanning apparatus 10 further comprises a control member 15, a driving member 16 and a storage member 17, which are also included in the casing 11. The contact image sensor 13 includes a light-emitting element 131, a lens 132 and an optical sensing element 133. The light-emitting element 131 is used as a light source to project a source light L11 onto the document 14 to be scanned. The source light L11 includes red, green and blue light. The light L12 reflected from the scanned document is focused by the lens 132. The focused light L12 is then imaged onto the optical sensing element 133 to convert the optical signals reflected from the scanned document 14 into corresponding image pixels.

The process for performing a scanning operation will be illustrated as follows. Firstly, the document 14 is placed on the transparent platform 12. Then, the light-emitting element 131 of the contact image sensor 13 performs a first scanning stroke on the first rectangular scanning region Z1 of the document 14 (as shown in FIG. 2(b)). Subsequently, the driving member 16 is controlled by the control member 15 to drive the contact image sensor 13 to perform a second scanning stroke on the second rectangular scanning region Z2 of the document 14. Successively, the third to the nth scanning strokes are performed on the third rectangular scanning region Z3 to the nth rectangular scanning region Zn. After the scanning operation is implemented, the image of the document 14 scanned by the contact image sensor 13 is transmitted to the storage member 17 and stored in the storage member 17. In addition, by means of the control member 15, the scanned image will be transmitted to an external data processing device 20 such as a personal computer, which is electrically connected to the control member 15 of the CIS scanning apparatus 10.

Referring to FIG. 3, the optical sensing units included in the optical sensing element 133 are schematically illustrated. For example, the optical sensing element 133 has 13,600 optical sensing units S1˜S13600. For each scanning stroke, under the control of the control member 15, the light-emitting element 131 of the contact image sensor 13 projects a red source light L11 onto one rectangular scanning region (e.g. Z2) on the document 14. The reflective red light L12, which is reflected from the scanned document 14, is focused by the lens 132 and uniformly imaged onto the optical sensing units S1˜S13600 of the optical sensing element 133. As a consequence, the optical sensing units S1˜S13600 generates 13,600 red sub-pixels R1˜R13600.

Likewise, under the control of the control member 15, the light-emitting element 131 of the contact image sensor 13 projects a green or blue source light L11 onto the selected rectangular scanning region (e.g. Z2) on the document 14. The reflective green or blue light L12, which is reflected from the scanned document 14, is focused by the lens 132 and uniformly imaged onto the optical sensing units S1˜S13600 of the optical sensing element 133. As a consequence, the optical sensing units S1˜S13600 will generate 13,600 green sub-pixels G1˜G13600 and 13,600 blue sub-pixels B1˜B13600.

The red sub-pixels R1˜R13600, the green sub-pixels G1˜G13600 and the blue sub-pixels B1˜B13600 can be stored in the storage member 17. By the control member 15, the sub-pixels R1, B1 and G1 are synthesized into a first pixel P1. Likewise, the sub-pixels R2, B2 and G2 are synthesized into a second pixel P2. The rest may be deduced by analogy, thereby resulting in an image row of 13,600 pixels P1˜P13600. After the image row of 13,600 pixels P1˜P13600 are stored in the storage member 17, a scanning stroke is implemented.

After the contact image sensor 13 performs the remainder scanning strokes on the document 14, a total of n image rows are generated. Under the control of the control member 15, the n image rows are synthesized into an image frame, which is then transmitted to the external data processing device 20.

As previously described, the length of the optical sensing element 133 is restricted by the width of the document 14. For increasing the resolution of the optical sensing element 133, the number of the optical sensing units should be increased. For example, if the resolution of the optical sensing element 133 needs to be tripled, the number of the optical sensing units should be increased from 13,600 to 40,800. Since the length of the optical sensing element 133 is limited, the process of fabricating triple optical sensing units becomes more complicated and is not cost-effective.

In views of the above-described disadvantages resulted from the prior art, the applicant keeps on carving unflaggingly to develop an improved contact image sensor for generating multi-resolutions according to the present invention through wholehearted experience and research.

### SUMMARY OF THE INVENTION

It is an object of the present invention to provide a contact image sensor for generating multi-resolutions in a simplified and cost-effective manner.

In accordance with an aspect of the present invention, there is provided a contact image sensor used in a scanning apparatus. The contact image sensor comprises a first optical sensing element and at least one additional optical sensing element. The first optical sensing element includes plural optical sensing units arranged in a line along a first direction. When the additional optical sensing element senses an additional source light, plural additional image units are successively generated. The at least one additional optical sensing element is disposed at a lateral side of the first optical sensing element, and includes plural optical sensing units arranged in a line along the first direction. When the additional optical sensing element senses an additional source light, plural additional image units are successively generated. The adjacent optical sensing units of the first optical sensing element and the at least one additional optical sensing element are partially overlapped with each other along a second direction, which is perpendicular to the first direction.

In an embodiment, the at least one additional optical sensing element includes a second optical sensing element and a third optical sensing element. The second optical sensing element is closer to the first third optical sensing element than the third optical sensing element.

In an embodiment, adjacent optical sensing units of the second optical sensing element and the third optical sensing element are partially overlapped with each other along the second direction. The overlapping region between every two adjacent optical sensing units of the first optical sensing element and the second optical sensing element along the second direction is one third of any optical sensing unit. The overlapping region between every two adjacent optical sensing units of the second optical sensing element and the third optical sensing element along the second direction is one third of any optical sensing unit.

In accordance with a further aspect of the present invention, there is provided a contact image sensor used in a scanning apparatus. The contact image sensor comprises a first optical sensing element and at least one additional optical sensing element. The first optical sensing element includes plural effective sensing sections arranged in a line along a first direction, wherein plural first pixels are successively generated when the first optical sensing element senses a first source light. The at least one additional optical sensing element is disposed at a lateral side of the first optical sensing element, and includes plural effective sensing sections arranged in a line along the first direction. When the additional optical sensing element senses an additional source light, plural additional pixels are successively generated. The adjacent effective sensing sections of the first optical sensing element and the at least one additional optical sensing element are partially overlapped with each other along a second direction, which is perpendicular to the first direction.

In an embodiment, the at least one additional optical sensing element includes a second optical sensing element and a third optical sensing element. The second optical sensing element is closer to the first third optical sensing element than the third optical sensing element. The effective sensing sections of the second optical sensing element and the third optical sensing element are arranged in a staggered form along the second direction.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional CIS scanning apparatus;

FIG. 2(a) is a schematic diagram illustrating the scanning operation concept of the CIS scanning apparatus 10;

FIG. 2(b) is schematic view showing n counts of rectangular scanning regions of the document portion of the CIS scanning apparatus 10;

FIG. 3 is a schematic diagram illustrating the optical sensing units included in the optical sensing element;

FIG. 4 is a schematic perspective view of a CIS scanning apparatus 30 according to the present invention;

FIG. 5 is a schematic diagram illustrating the scanning operation concept of the CIS scanning apparatus 30;

FIG. 6 is a schematic diagram of the optical sensing member 333 according to a first embodiment of the present invention;

FIG. 7 is a flowchart illustrating the process of the using the contact image sensor 33 of FIG. 5 to perform a scanning operation;

FIG. 8 is a schematic diagram of the optical sensing member 333 according to a second embodiment of the present invention; and

FIG. 9 is a schematic diagram of the optical sensing member 333 according to a third embodiment of the present invention.

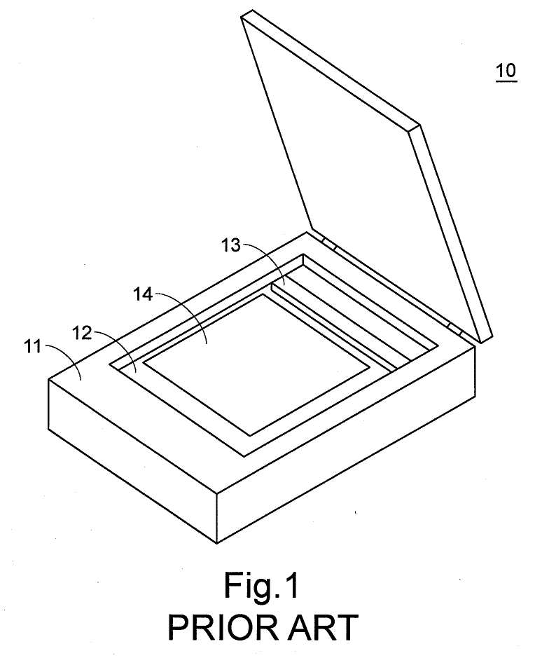

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

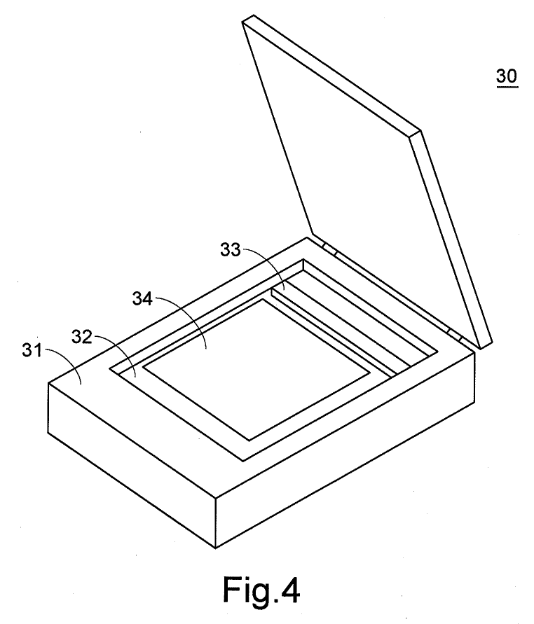

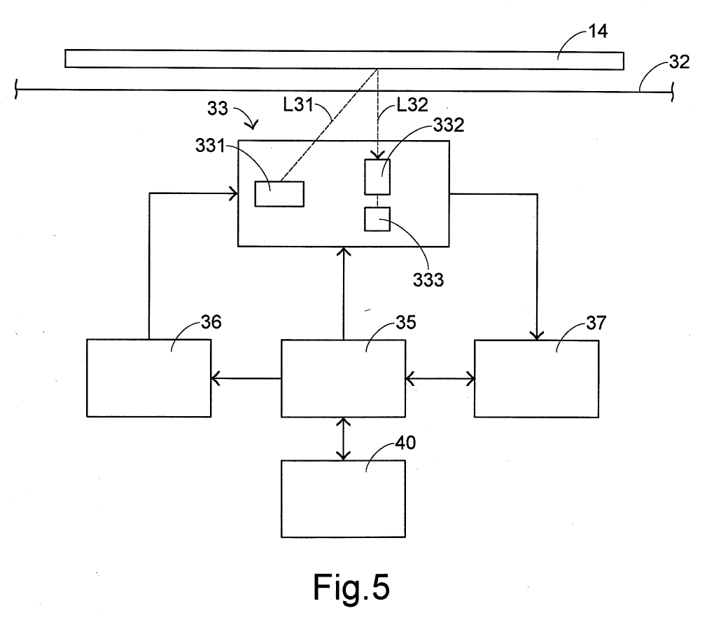

Please refer to FIGS. 4 and 5. FIG. 4 is a schematic perspective view of a CIS scanning apparatus 30 according to the present invention. FIG. 5 is a schematic diagram illustrating the scanning operation concept of the CIS scanning apparatus 30. The CIS scanning apparatus 30 includes a casing 31, a transparent platform 32 and a contact image sensor (CIS) 33. The transparent platform 32 is disposed on the upper surface of the casing 31 and used for placing thereon the document 34 to be scanned. The CIS scanning apparatus 30 further comprises a control member 35, a driving member 36 and a storage member 37, which are also included in the casing 31. The contact image sensor 33 includes a light-emitting element 331, a lens 332 and an optical sensing member 333. The light-emitting element 331 is used as a light source to project a source light L31 onto the document 34 to be scanned. The source light L31 includes red, green and blue light. The light L32 reflected from the scanned document is focused by the lens 332. The focused light L32 is then imaged onto the optical sensing member 333 to convert the optical signals reflected from the scanned document 34 into corresponding image pixels.

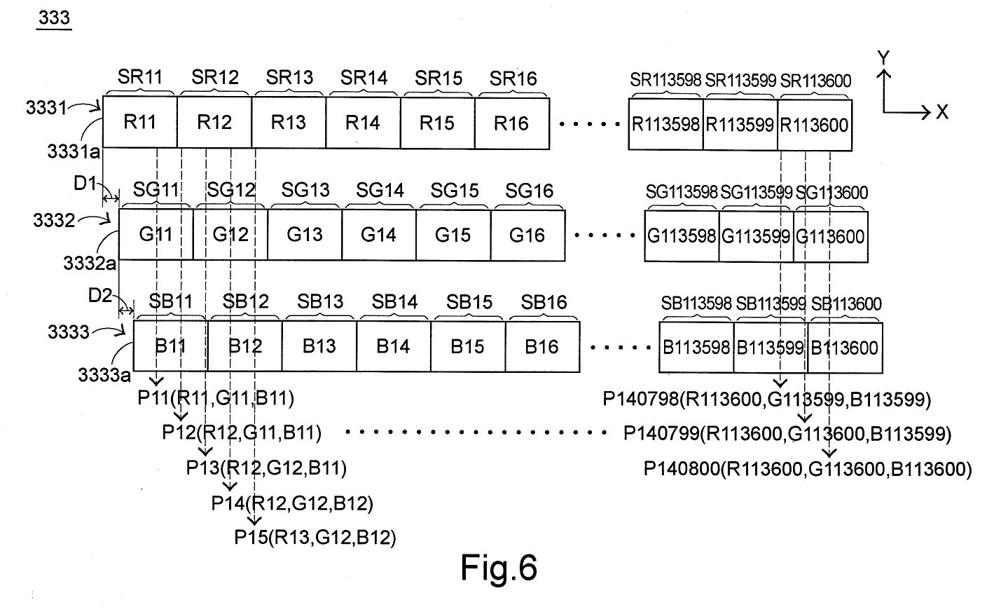

Referring to FIG. 6, a schematic diagram of the optical sensing member 333 according to a first embodiment of the present invention is illustrated. The process of using the contact image sensor 33 to perform a scanning operation will be illustrated as follows. As shown in FIG. 6, the present invention is principally distinguished from the prior art in that the optical sensing member 333 includes three rows of optical sensing elements 3331, 3332 and 3333 arranged in parallel with each other. The optical sensing elements 3331, 3332 and 3333 have 13,600 optical sensing units SR11˜SR113600, 13,600 optical sensing units SG11˜SG113600 and 13,600 optical sensing units SB11˜SB113600, respectively, which are arranged in a line along the X direction. It is preferred that at least two of the optical sensing elements 3331, 3332 and 3333 have equivalent lengths.

An end 3331a of the first optical sensing elements 3331 is distant from an end 3332a of the second optical sensing elements 3332 by a distance D1 along the X direction. The end 3332a of the second optical sensing elements 3332 is distant from an end 3333a of the third optical sensing elements 3333 by a distance D2 along the X direction. In a preferred embodiment, the distance D1 is equal to the distance D2, and the distance D1 or D2 is preferably one half or one third of any optical sensing unit.

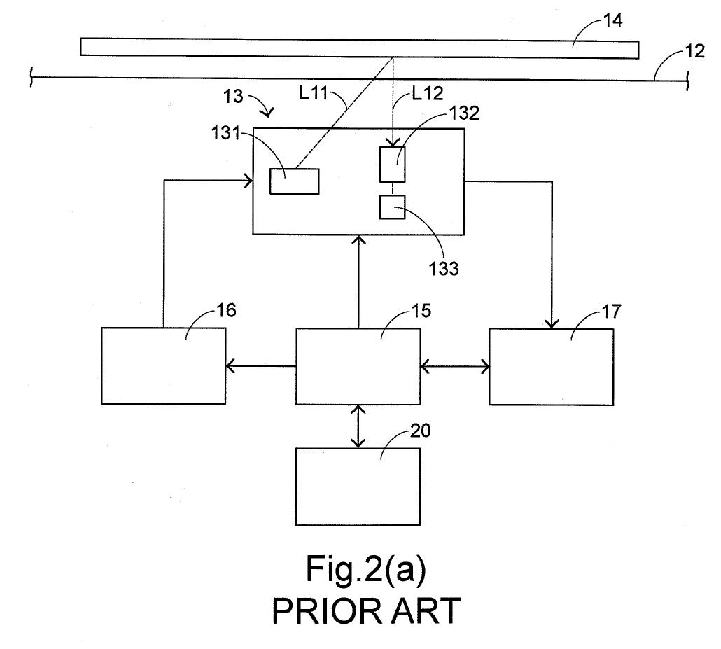

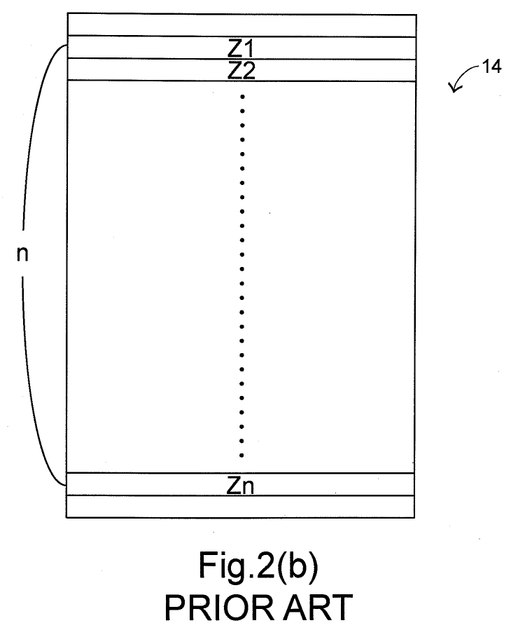

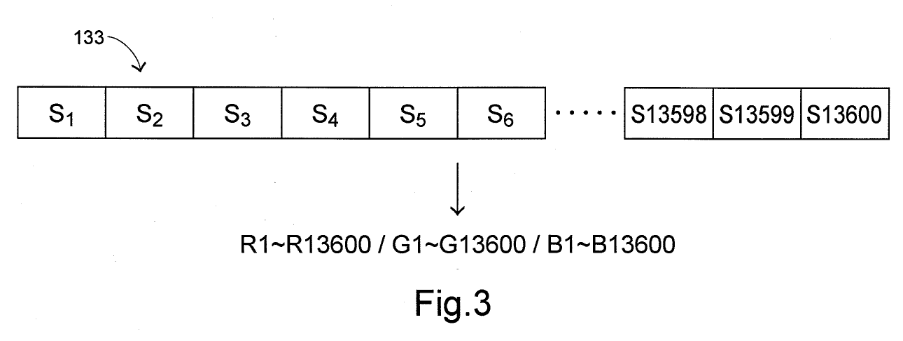

For each scanning stroke, under the control of the control member 35, the light-emitting element 331 of the contact image sensor 33 projects a red source light L31 onto one rectangular scanning region (e.g. Z2 as shown in FIG. 2(b)) on the document 34. The reflective red light L32, which is reflected from the scanned document 34, is focused by the lens 332 and uniformly imaged onto the optical sensing elements 3331, 3332 and 3333 of the optical sensing member 333. In accordance with a feature of the present invention, under the control of the control member 35, the optical sensing units SR11˜SR113600 of the first optical sensing element 3331 are enabled, but the optical sensing units SG11˜SG113600 of the second optical sensing element 3332 and the optical sensing units SB11˜SB113600 of the third optical sensing element 3333 are disabled. Under this circumstance, the control member 35 control the optical sensing units SR11˜SR113600 of the first optical sensing element 3331 to generate 13,600 red sub-pixels R11˜R113600.

Likewise, under the control of the control member 35, the light-emitting element 331 of the contact image sensor 13 may successively project a green or blue source light L31 onto the selected rectangular scanning region (e.g. Z2) on the document 34. The reflective green or blue light L32, which is reflected from the scanned document 34, is focused by the lens 332 and uniformly imaged onto the optical sensing units SG11˜SG113600 of the second optical sensing element 3332 and the optical sensing units SB11˜SB113600 of the third optical sensing element 3333. The red sub-pixels R11˜R113600, the green sub-pixels G11˜G113600 and the blue sub-pixels B11˜B113600 can be stored in the storage member 37.

By the control member 35, corresponding sub-pixels generated from the three optical sensing elements can be synthesized into combined pixels. For example, the sub-pixels R11, B11 and G11 are synthesized into a first pixel P11. Likewise, the sub-pixels R12, B11 and G11 are synthesized into a second pixel P12, the sub-pixels R12, B11 and G12 are synthesized into a third pixel P13, and the sub-pixels R12, B12 and G12 are synthesized into a fourth pixel P14. The rest may be deduced by analogy until the 40799th pixel P140799 is synthesized from the sub-pixels R113600, B113599 and G113599 and the 40800th pixel P140800 is synthesized from the sub-pixels R113600, B113600 and G113600. The control member 35 will control the 40800 pixels P11˜P140800 to form an image row. After the image row is stored in the storage member 37, a scanning stroke is implemented. It is noted that a total of n image rows are generated when the contact image sensor 33 performs the remainder scanning strokes on the document 34. By the control member 35, the n image rows are synthesized into an image frame, which is then transmitted to the external data processing device 40.

Please refer to FIG. 6 again. The optical sensing elements 3331, 3332 and 3333 of the optical sensing member 333 are arranged in a staggered form, such that adjacent optical sensing units of the optical sensing elements 3331, 3332 and 3333 are partially overlapped with each other along the Y-direction. In a preferred embodiment, the overlapping region is one half or one third of any optical sensing unit. As a consequence, the sub-pixel generated from each optical sensing unit contributes to the components of three combined pixels. For example, the sub-pixel R12 generated from the optical sensing unit is one component of each of the pixels P12, P13 and P14. In such way, by using the contact image sensor 33 to perform a scanning operation, 40,800 pixels are obtained. That is, the resolution is tripled without difficulty.

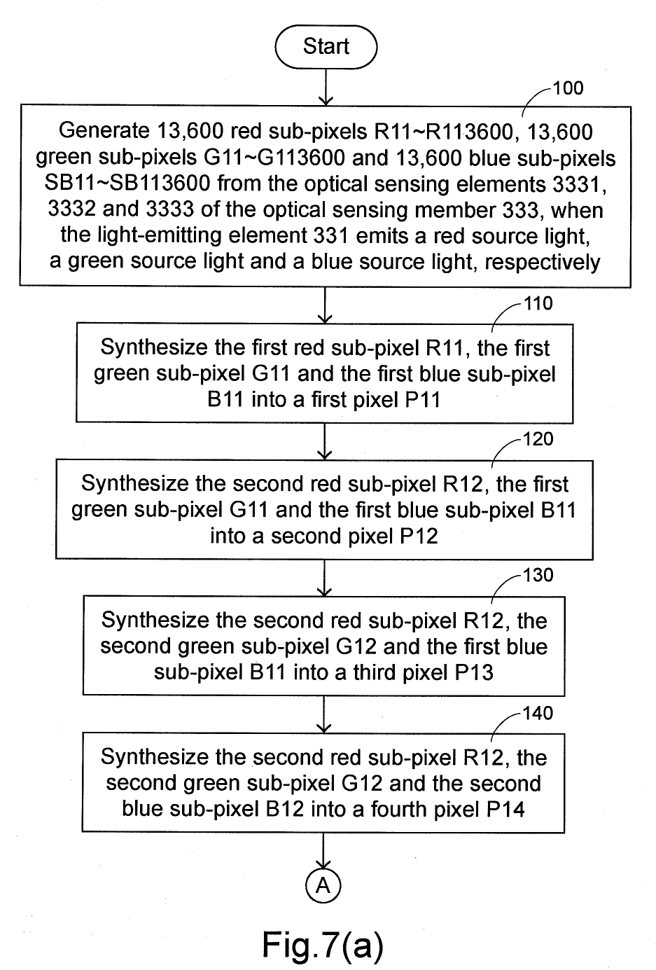

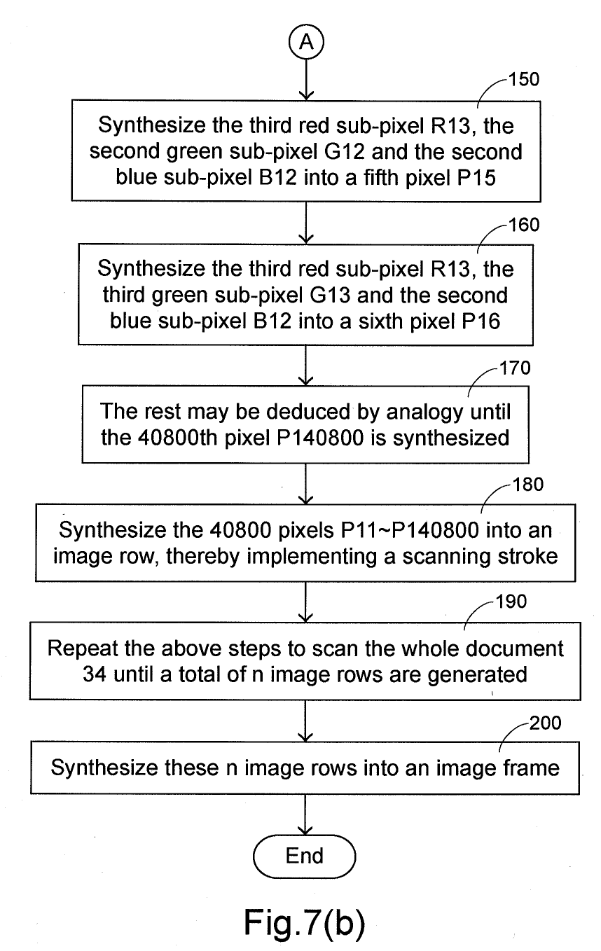

Hereinafter, a flowchart of the using the contact image sensor 33 of FIG. 5 to perform a scanning operation will be illustrated with reference to FIG. 7.

First of all, when the light-emitting element 331 emits a red source light, a green source light and a blue source light, the optical sensing elements 3331, 3332 and 3333 of the optical sensing member 333 will generate 13,600 red sub-pixels R11˜R113600, 13,600 green sub-pixels G11˜G113600 and 13,600 blue sub-pixels SB11˜SB113600, respectively (Step 100). Then, the first red sub-pixel R11, the first green sub-pixel G11 and the first blue sub-pixel B11 are synthesized into a first pixel P11 (Step 110). The second red sub-pixel R12, the first green sub-pixel G11 and the first blue sub-pixel B11 are synthesized into a second pixel P12 (Step 120). The second red sub-pixel R12, the second green sub-pixel G12 and the first blue sub-pixel B11 are synthesized into a third pixel P13 (Step 130). The second red sub-pixel R12, the second green sub-pixel G12 and the second blue sub-pixel B12 are synthesized into a fourth pixel P14 (Step 140). The third red sub-pixel R13, the second green sub-pixel G12 and the second blue sub-pixel B12 are synthesized into a fifth pixel P15 (Step 150). The third red sub-pixel R13, the third green sub-pixel G13 and the second blue sub-pixel B12 are synthesized into a sixth pixel P16 (Step 160). The rest may be deduced by analogy until the 40800th pixel P140800 is synthesized from the sub-pixels R113600, B113600 and G113600 (Step 170). Then, the 40800 pixels P11˜P140800 are formed into an image row to implement a scanning stroke (Step 180). The above steps are repeated to scan the whole document 34 until a total of n image rows are generated (Step 190). Afterwards, these n image rows are synthesized into an image frame (Step 200).

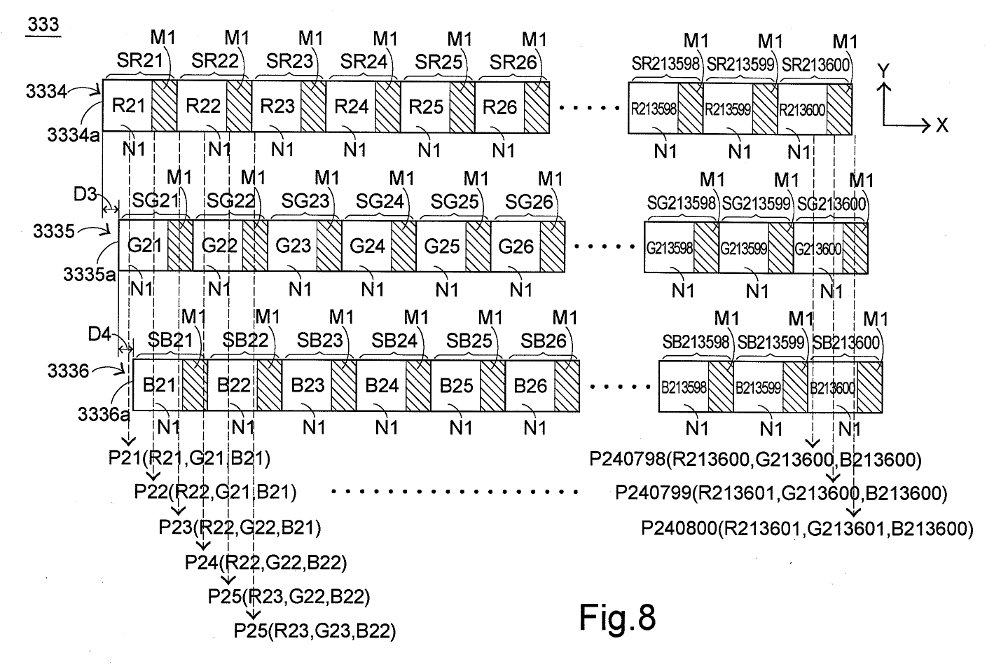

Referring to FIG. 8, a schematic diagram of the optical sensing member 333 according to a second embodiment of the present invention is illustrated. The optical sensing member 333 includes three rows of optical sensing elements 3334, 3335 and 3336 arranged in parallel with each other. The optical sensing elements 3334, 3335 and 3336 have 13,600 optical sensing units SR21˜SR213600, 13,600 optical sensing units SG21˜SG213600 and 13,600 optical sensing units SB21˜SB213600, respectively, which are arranged in a line along the X direction. It is preferred that at least two of the optical sensing elements 3334, 3335 and 3336 have equivalent lengths. An end 3334a of the first optical sensing elements 3334 is distant from an end 3335a of the second optical sensing elements 3335 by a distance D3 along the X direction. The end 3335a of the second optical sensing elements 3335 is distant from an end 3336a of the third optical sensing elements 3336 by a distance D4 along the X direction. In a preferred embodiment, the distance D3 is equal to the distance D4, which is preferably one half or one third of any optical sensing unit. In comparison with the first embodiment, each optical sensing unit of the optical sensing elements 3334, 3335 and 3336 of this embodiment has an effective sensing section N1 and an ineffective sensing section M1. In a preferred embodiment, the area of the effective sensing section N1 is two third of the total area for each optical sensing unit, and the area of the ineffective sensing section M1 is one third of the total area for each optical sensing unit. The ineffective sensing section M1 is formed via a masking step. The effective sensing sections N1 of the optical sensing elements 3334, 3335 and 3336 are arranged in a staggered form, such that adjacent effective sensing sections N1 of the optical sensing elements 3334, 3335 and 3336 are partially overlapped with each other along the Y-direction. In a preferred embodiment, the overlapping region is one half of the effective sensing sections N1.

In this embodiment, the procedure of synthesizing the sub-pixels into a combined pixel is substantially identical to that described in the first embodiment. In other words, the sub-pixel generated from each optical sensing unit contributes to the components of three combined pixels. It is noted that, if the sampled sub-pixel is located at the ineffective sensing section M1 of one optical sensing unit, the sub-pixel sensed by the effective sensing sections N1 of the next optical sensing unit is selected as the component of the combined pixel. For example, as shown in FIG. 8, the sampling positions of the second pixel P22 include the ineffective sensing section M1 of the first optical sensing unit SR21 of the first optical sensing element 3334, the effective sensing sections N1 of the first optical sensing unit SG21 of the second optical sensing element 3335 and the effective sensing sections N1 of the first optical sensing unit SB21 of the third optical sensing element 3336. Since the sampled sub-pixel is located at the ineffective sensing section M1 of the first optical sensing unit SR21 of the first optical sensing element 3334, the sub-pixel R22 sensed by the effective sensing sections N1 of the next optical sensing unit SR22 is selected as the component of the combined pixel. That is, the second pixel P22 is synthesized from the second red sub-pixel R22, the first green sub-pixel G21 and the first blue sub-pixel B21. Similarly, the sampling positions of the second pixel P22 include the effective sensing sections N1 of second optical sensing unit SR22 of the first optical sensing element 3334, the ineffective sensing section M1 of the first optical sensing unit SG21 of the second optical sensing element 3335 and the effective sensing sections N1 of the first optical sensing unit SB21 of the third optical sensing element 3336. Since the sampled sub-pixel is located at the ineffective sensing section M1 of the first optical sensing unit SG21 of the second optical sensing element 3335, the second green sub-pixel G22 sensed by the effective sensing sections N1 of the next optical sensing unit GR22 is selected as the component of the combined pixel. That is, the third pixel P23 is synthesized from the second red sub-pixel R22, the second green sub-pixel G22 and the first blue sub-pixel B21. In such way, by using the contact image sensor 33 to perform a scanning operation, 40,800 pixels are obtained. That is, the resolution is tripled without difficulty.

By the way, although the first optical sensing unit SB21 of the third optical sensing element 3336 is not directly aligned with the sampling positions of the second pixel P21, the sub-pixel B21 sensed by the effective sensing sections N1 of the next optical sensing unit SB21 is selected as the component of the combined pixel, so that the first pixel P21 is synthesized from the first red sub-pixel R21, the first green sub-pixel G21 and the first blue sub-pixel B21. In addition, the sub-pixels R213601 and G213601 contained in the 40799th pixel P240799 and the 40800th pixel P240800 are sensed by two additional optical sensing units (not shown). Alternatively, the red sub-pixel R213601 and the green sub-pixel G213601 are pre-determined.

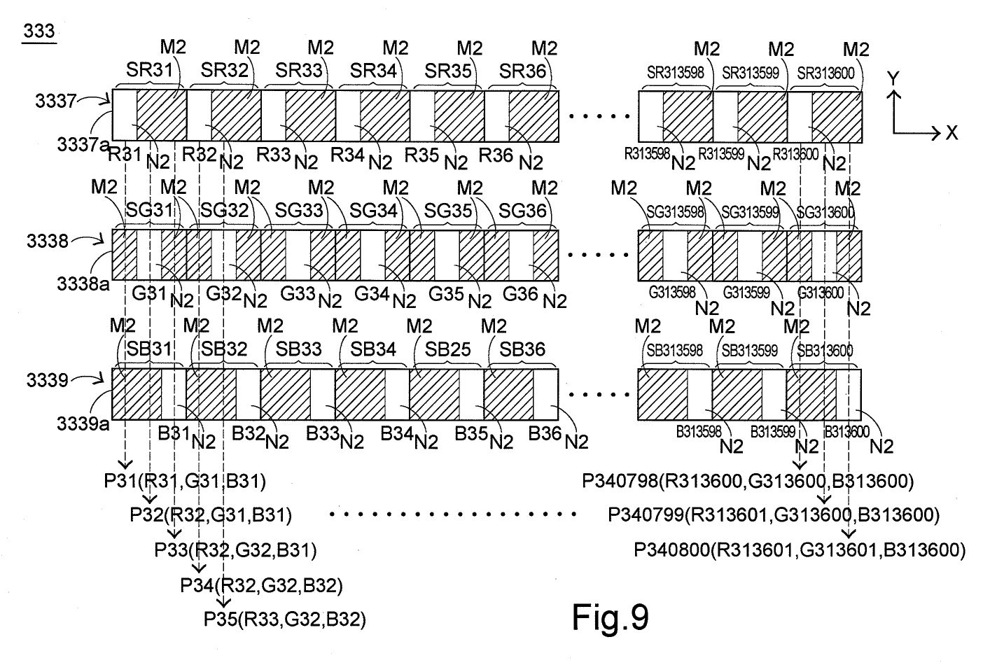

Referring to FIG. 9, a schematic diagram of the optical sensing member 333 according to a third embodiment of the present invention is illustrated. The optical sensing member 333 includes three rows of optical sensing elements 3337, 3338 and 3339 arranged in parallel with each other. The optical sensing elements 3337, 3338 and 3339 have 13,600 optical sensing units SR31˜SR313600, 13,600 optical sensing units SG31˜SG313600 and 13,600 optical sensing units SB31˜SB313600, respectively, which are arranged in a line along the X direction. It is preferred that at least two of the optical sensing elements 3337, 3338 and 3339 have equivalent lengths. An end 3337a of the first optical sensing elements 3337, an end 3338a of the second optical sensing elements 3338 and an end 3339a of the second optical sensing elements 3339 are aligned with each other along the X direction. Each optical sensing unit of the optical sensing elements 3337, 3338 and 3339 of this embodiment has an effective sensing section N2 and an ineffective sensing section M2. In comparison with the first embodiment, the area of the effective sensing section N2 is one third of the total area for each optical sensing unit, and the area of the ineffective sensing section M2 is two third of the total area for each optical sensing unit. The ineffective sensing section M1 can be formed via a masking step. In this embodiment, the effective sensing sections N2 of the optical sensing elements 3337, 3338 and 3339 are arranged in a staggered form, but adjacent effective sensing sections N2 of the optical sensing elements 3337, 3338 and 3339 are not overlapped with each other along the Y-direction. The procedure of synthesizing the sub-pixels into a combined pixel is substantially identical to that described in the second embodiment, and is not redundantly described herein. Likewise, the sub-pixels R213601 and G213601 contained in the 40799th pixel P240799 and the 40800th pixel P240800 are sensed by two additional optical sensing units (not shown) or predetermined.

As described in the second embodiment and the third embodiment, the effective sensing sections of the optical sensing elements are arranged in a staggered form. Since the sub-pixel generated from each optical sensing unit contributes to the components of three different combined pixels, the scanning resolution is tripled without difficulty. It is noted that, however, those skilled in the art will readily observe that the area ratio of the effective sensing section to each optical sensing unit is varied according to the manufacturer's design.

From the above description, the contact image sensor 33 of the present invention is capable of largely enhancing the resolution of the scanning apparatus without considerably increasing the fabrication cost. By using three conventional optical sensing elements, in which the optical sensing units/effective sensing sections are arranged in a staggered form, the sub-pixel generated from each optical sensing unit contributes to the components of three different combined pixels. Accordingly, after the contact image sensor 33 as shown in FIG. 5 implements a scanning operation, the resolution can be increased to 40,800, provided that each of the three optical sensing elements has 13,600 optical sensing units.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A contact image sensor used in a scanning apparatus, said contact image sensor comprising:
a first optical sensing element including plural optical sensing units arranged in a line along a first direction, wherein plural first image units are successively generated when said first optical sensing element senses a first source light; and
at least one additional optical sensing element disposed at a lateral side of said first optical sensing element, and including plural optical sensing units arranged in a line along said first direction, wherein plural additional image units are successively generated when said additional optical sensing element senses an additional source light,
wherein adjacent optical sensing units of said first optical sensing element and said at least one additional optical sensing element are partially overlapped with each other along a second direction, which is perpendicular to said first direction.

2. The contact image sensor according to claim 1 wherein the overlapping region between every two adjacent optical sensing units of said first optical sensing element and said at least one additional optical sensing element along said second direction is one half of any optical sensing unit.

3. The contact image sensor according to claim 1 wherein said at least one additional optical sensing element includes a second optical sensing element and a third optical sensing element, said second optical sensing element being closer to said first third optical sensing element than said third optical sensing element.

4. The contact image sensor according to claim 3 wherein adjacent optical sensing units of said second optical sensing element and said third optical sensing element are partially overlapped with each other along said second direction.

5. The contact image sensor according to claim 4 wherein the overlapping region between every two adjacent optical sensing units of said first optical sensing element and said second optical sensing element along said second direction is one third of any optical sensing unit, and the overlapping region between every two adjacent optical sensing units of said second optical sensing element and said third optical sensing element along said second direction is one third of any optical sensing unit.

6. The contact image sensor according to claim 3 wherein said first optical sensing element, said second optical sensing element and said third optical sensing element are a red light sensing element, a green light sensing element and a blue light sensing element, respectively.

7. The contact image sensor according to claim 3 wherein each optical sensing unit of said first optical sensing element, said second optical sensing element and said third optical sensing element has an effective sensing section.

8. The contact image sensor according to claim 7 wherein said effective sensing sections of said first optical sensing element and said second optical sensing element are arranged in a staggered form along said second direction, and said effective sensing sections of said second optical sensing element and said third optical sensing element are arranged in a staggered form along said second direction.

9. The contact image sensor according to claim 7 wherein each optical sensing unit of said first optical sensing element, said second optical sensing element and said third optical sensing element has an ineffective sensing section, which is formed by masking a portion of said optical sensing unit.

10. A contact image sensor used in a scanning apparatus, said contact image sensor comprising:
a first optical sensing element including plural effective sensing sections arranged in a line along a first direction, wherein plural first pixels are successively generated when said first optical sensing element senses a first source light; and
at least one additional optical sensing element disposed at a lateral side of said first optical sensing element, and including plural effective sensing sections arranged in a line along said first direction, wherein plural additional pixels are successively generated when said additional optical sensing element senses an additional source light,
wherein adjacent effective sensing sections of said first optical sensing element and said at least one additional optical sensing element are partially overlapped with each other along a second direction, which is perpendicular to said first direction.

11. The contact image sensor according to claim 10 wherein said at least one additional optical sensing element includes a second optical sensing element and a third optical sensing element, said second optical sensing element is closer to said first third optical sensing element than said third optical sensing element, and said effective sensing sections of said second optical sensing element and said third optical sensing element are arranged in a staggered form along said second direction.

12. The contact image sensor according to claim 11 wherein each of said first, second and said third optical sensing elements further has plural optical sensing units, and said effective sensing sections are individually formed on said optical sensing units of said first, second and said third optical sensing elements.

13. The contact image sensor according to claim 12 wherein each optical sensing unit of said first optical sensing element, said second optical sensing element and said third optical sensing element has an ineffective sensing section, which is formed by masking a portion of said optical sensing unit.

14. The contact image sensor according to claim 12 wherein the overlapping region between every two adjacent optical sensing units of said first optical sensing element and said second optical sensing element along said second direction is one third of any optical sensing unit, and the overlapping region between every two adjacent optical sensing units of said second optical sensing element and said third optical sensing element along said second direction is one third of any optical sensing unit.

15. An image scanning method used with a contact image sensor for producing an image frame, said contact image sensor comprising first, second and third optical sensing elements respectively having plural optical sensing units along a first direction, said image scanning method comprising steps of:
(A) emitting first, second and third source lights, and successively generating plural image units from said plurality of optical sensing units of said first, second and third optical sensing elements in response to said first, second and third source lights, respectively;
(B) synthesizing the image unit generated from the first optical sensing unit of said first optical sensing element, the image unit generated from the first optical sensing unit of said second optical sensing element and the image unit generated from the first optical sensing unit of said third optical sensing element into a first pixel;
(C) synthesizing the image unit generated from the second optical sensing unit of said first optical sensing element, the image unit generated from the first optical sensing unit of said second optical sensing element and the image unit generated from the first optical sensing unit of said third optical sensing element into a second pixel;
(D) synthesizing the image unit generated from the second optical sensing unit of said first optical sensing element, the image unit generated from the second optical sensing unit of said second optical sensing element and the image unit generated from the first optical sensing unit of said third optical sensing element into a third pixel;
(E) synthesizing the image unit generated from the second optical sensing unit of said first optical sensing element, the image unit generated from the second optical sensing unit of said second optical sensing element and the image unit generated from the second optical sensing unit of said third optical sensing element into a fourth pixel;
(F) synthesizing the image unit generated from the third optical sensing unit of said first optical sensing element, the image unit generated from the second optical sensing unit of said second optical sensing element and the image unit generated from the second optical sensing unit of said third optical sensing element into a fifth pixel;
(G) synthesizing the image unit generated from the third optical sensing unit of said first optical sensing element, the image unit generated from the third optical sensing unit of said second optical sensing element and the image unit generated from the second optical sensing unit of said third optical sensing element into a sixth pixel;
(H) repeating the above steps until the last pixel is synthesized; and
(I) forming all the pixels generated in the above steps into an image row.

16. The image scanning method according to claim 15 wherein the overlapping region between every two adjacent optical sensing units of said first optical sensing element and said second optical sensing element along said second direction is one third of any optical sensing unit, and the overlapping region between every two adjacent optical sensing units of said second optical sensing element and said third optical sensing element along said second direction is one third of any optical sensing unit.

17. The image scanning method according to claim 15 wherein each optical sensing unit of said first optical sensing element, said second optical sensing element and said third optical sensing element has an effective sensing section.

18. The image scanning method according to claim 17 wherein said effective sensing sections of said first optical sensing element and said second optical sensing element are arranged in a staggered form along said second direction, and said effective sensing sections of said second optical sensing element and said third optical sensing element are arranged in a staggered form along said second direction.

19. The image scanning method according to claim 17 wherein each optical sensing unit of said first optical sensing element, said second optical sensing element and said third optical sensing element has an ineffective sensing section, which is formed by masking a portion of said optical sensing unit.

20. The image scanning method according to claim 15 wherein said first, second and third source lights are a red light, a green light and a blue light, respectively.
